(19) United States
(12) Patent Application Publication
(10) Pub. No.: US 2015/0213165 A1
(43) Pub. Date: Jul. 30, 2015

(54) Methods And Systems For Conducting Design Sensitivity Analysis

(71) Applicant: Livermore Software Technology Corporation, Livermore, CA (US)

(72) Inventor: Willem J. Roux, Livermore, CA (US)

(73) Assignee: Livermore Software Technology Corporation, Livermore, CA (US)

(21) Appl. No.: 14/165,472

(22) Filed: Jan. 27, 2014

(51) Int. Cl. G06F 17/50

(52) U.S. Cl. CPC G06F 17/5018; G06F 17/5095

(57) ABSTRACT

Methods and systems for conducting design sensitivity analysis of a product are disclosed. FEA model representing a product is received in a computer system having a FEA software installed thereon. The FEA software is configured for using both explicit and implicit solution schemes and allowing the FEA model to be switched back and forth between said explicit and said implicit solution schemes. Numerically simulated structural behaviors are then obtained by conducting a time-marching simulation using the FEA model in the computer system with the explicit solution scheme. Then, DSA is conducted by performing one or more snapshot structural analyses at respective predetermined solution cycles using the same FEA model with the implicit solution scheme. Each snapshot structural analysis is based on the simulated structural behaviors obtained at that solution cycle. The DSA includes one or more partial derivatives of a structural response of interest versus a selected design variable.

### FIELD

The present invention generally relates to computer aided engineering design optimization, more particularly to methods and systems for conducting design sensitivity analysis of a product.

### BACKGROUND

Today, computer aided engineering (CAE) has been used for supporting engineers in tasks such as analysis, simulation, design, manufacture, etc. In a conventional engineering design procedure, CAE analysis (e.g., finite element analysis (FEA), finite difference analysis, meshless analysis, computational fluid dynamics (CFD) analysis, modal analysis for reducing noise-vibration-harshness (NVH), etc.) has been employed to evaluate responses (e.g., stresses, displacements, etc.). Using automobile design as an example, a particular version or design of a car is analyzed using FEA to obtain the responses due to certain loading conditions. Engineers will then try to improve the car design by modifying certain parameters or design variables (e.g., thickness of the steel shell, locations of the frames, etc.) based on specific objectives and constraints. Another FEA is conducted to reflect these changes until a “best” design has been achieved. However, this approach generally depends on knowledge of the engineers or based on a trial-and-error method. To solve this problem, a systematic approach (referred to as design optimization) to identify the “best” design is used.

Traditionally, design optimization is performed with a computer system and generally divided into three categories, sizing, shape and topology. Topology optimization is best suited for creating optimal conceptual design in which the user (i.e., engineer, designer, etc.) does not have put too many constraints as to the shape and/or size of the engineering product. Additionally, design sensitivity analysis (DSA) is performed in conjunction with design optimization to ensure a “best” design can be predicted with CAE. There are problems related to using explicit solver in simulations of automobile crash. Modern practices use large number of finite elements (e.g., 1,000,000 plus elements) for modeling an automobile. As a result, a time-marching simulation of such a FEA model requires overnight run of a multi-processor computer system. Which makes impractical to conduct DSA in a time-marching simulation with explicit FEA solver alone. One solution is to conduct DSA using an equivalent model with implicit solver in conjunction with the original model with explicit solver. However, not only is it too costly to develop a sensitivity analysis methodology for both implicit and explicit solvers, but developing the equivalent model for the implicit analysis introduces an additional large cost born by the user. Therefore, it would be desirable to have improved methods and systems for conducting design sensitivity analysis of a product with a single methodology valid for the both explicit and implicit solution schemes at desired times in a time-marching simulation. Such a method will have neither the costs of developing the sensitivity analysis for explicit schemes in addition to the implicit scheme, nor the cost of developing an equivalent implicit analysis model in addition to the explicit analysis model.

### BRIEF SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

The present invention discloses methods and systems for conducting design sensitivity analysis of a product based on simulated structural behaviors obtained from a time-marching simulation. According to one aspect of the present invention, a FEA model representing a product is created and received in a computer system, which has a FEA application module installed thereon. The FEA application module is configured for using both explicit and implicit solution schemes and allowing the FEA model to be switched back and forth between said explicit and said implicit solution schemes. The FEA model includes a number of nodes connected by a plurality of finite elements. Numerically simulated structural behaviors are then obtained by conducting a time-marching simulation using the FEA model in the computer system with the explicit solution scheme. The time-marching simulation contains a number of solution cycles in time. Then a design sensitivity analysis (DSA) is conducted by performing one or more snapshot structural analyses at respective predetermined solution cycles using the same FEA model with the implicit solution scheme. Each snapshot structural analysis is based on the simulated structural behaviors obtained at corresponding predetermined solution cycle. The DSA includes one or more partial derivatives of a structural response of interest versus a selected design variable. Results of DSA are used for improving the product to be optimally designed.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an exemplary process of conducting design sensitivity analysis of a product based on simulated structural behaviors obtained from a time-marching simulation, according to an embodiment of the present invention;

FIG. 2 is a diagram showing graphical results of a car crash simulation (a time marching simulation of a product);

FIG. 3A is a diagram illustrating exemplary response versus time obtained in a time marching simulation, according to an embodiment of the present invention;

FIG. 3B is a diagram illustrating exemplary response versus design variable obtained in a design sensitivity analysis, according an embodiment of the present invention;

FIG. 4 is a diagram showing initial configuration of an exemplary part (i.e., knee bolster) to be optimized in accordance with one embodiment of the present invention;

FIG. 5 is a diagram showing optimal configuration of the exemplary part using design sensitivity analysis, according to an embodiment of the present invention; and

FIG. 6 is a function diagram showing salient components of a computing device, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Additionally, the term “optimal design” in this document is intended to indicate a design that meets the design requirements (e.g., goal, objective and constraint) in an iterative optimization design process. Furthermore, the terms “optimal configuration”, “optimal design”, “substantially improved design”, “significantly improved design” and “final design” are used interchangeably throughout this document. Finally, the order of blocks in process flowcharts or diagrams representing one or more embodiments of the invention do not inherently indicate any particular order nor imply any limitations in the invention.

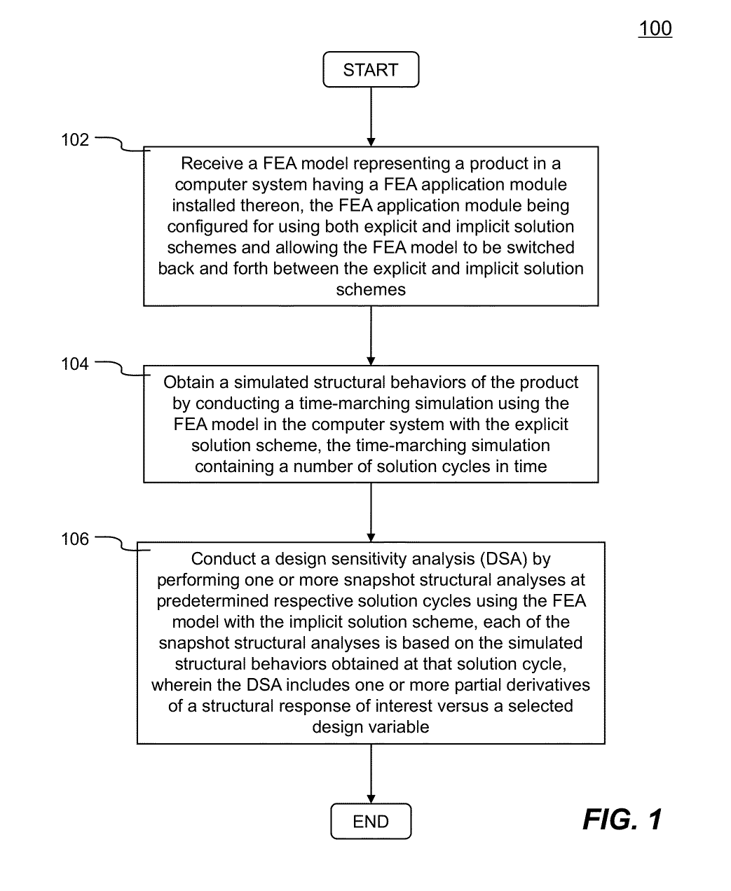

Embodiments of the present invention are discussed herein with reference to FIGS. 1-6. However, those skilled in the art will readily appreciate that the detailed description given herein with respect to these figures is for explanatory purposes as the invention extends beyond these limited embodiments.

Referring first of FIG. 1, it is shown a flowchart illustrating an exemplary process 100 of conducting design sensitivity analysis of a product based on simulated structural behaviors obtained from a time-marching simulation. Process 100 is preferably implemented in software.

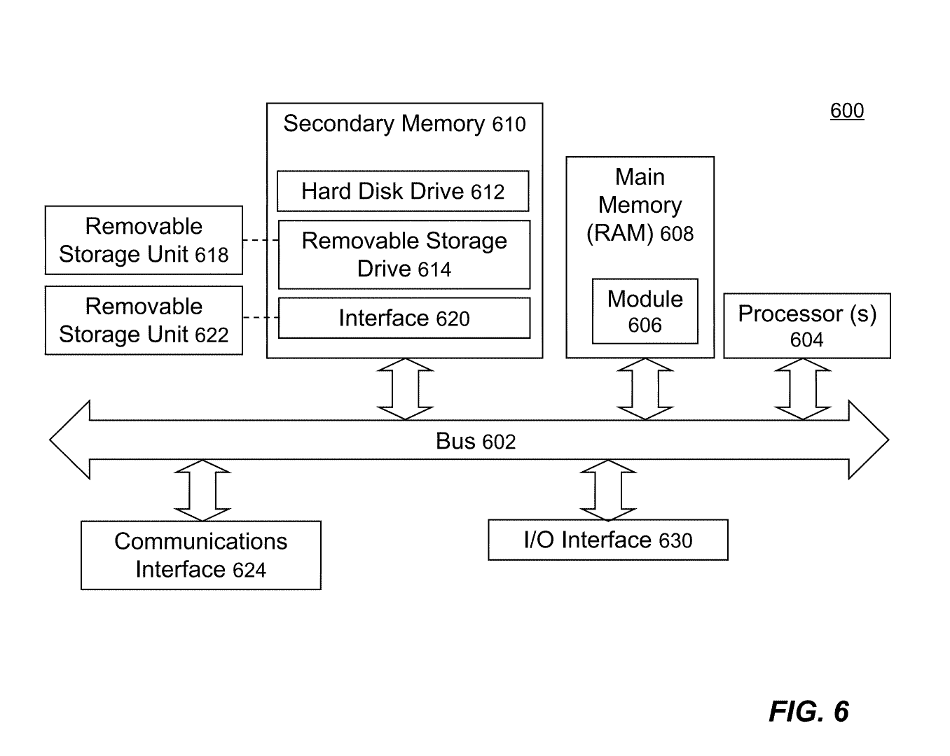

At the onset (step 102), process 100 receives a finite element analysis model of a product (e.g., a car, an airplane, a component, etc.) in a computer system (e.g., computer 600 of FIG. 6) having a finite element analysis (FEA) application module installed thereon. The FEA application is configured for using both explicit and implicit solution schemes and for allowing the FEA model to be switched between the two solution schemes. The FEA model contains a number of nodal points connected by a number of finite elements. According to one embodiment, a control indicator (e.g., a flag in software) for allowing switching between two solution schemes is implemented is implemented in such a FEA application module.

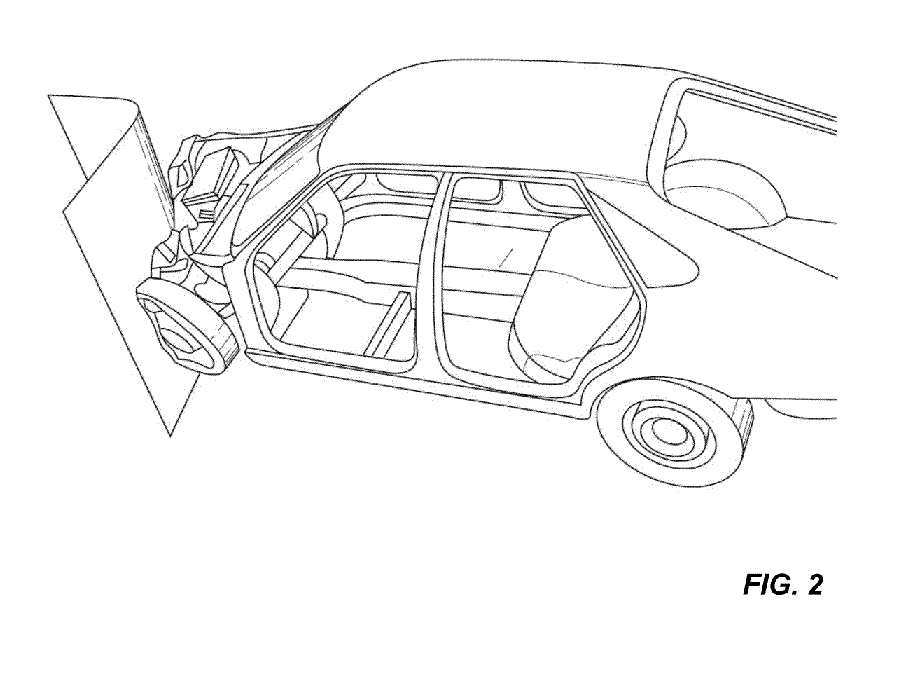

Next, at step 104, simulated structural behaviors of the product are obtained by conducting a time-marching simulation using the FEA model in the computer system using the explicit solution scheme. The time-marching simulation contains a number of solution cycles in time. The simulated structural behaviors include dynamic effects of the product. One exemplary simulation is a car crash simulation. FIG. 2 shows an exemplary results of a car crash simulation.

Then, at step 106, a design sensitivity analysis (DSA) is conducted by performing one or more snapshot structural analyses at predetermined solution cycles using the FEA model with the implicit solution scheme. Each of the snapshot structural analyses is based on the simulated structural behaviors of a configuration obtained at corresponding predetermined solution cycle with the explicit solution scheme. The DSA includes one or more partial derivatives of a structural response of interest versus a selected design variable for a particular design objective of the product.

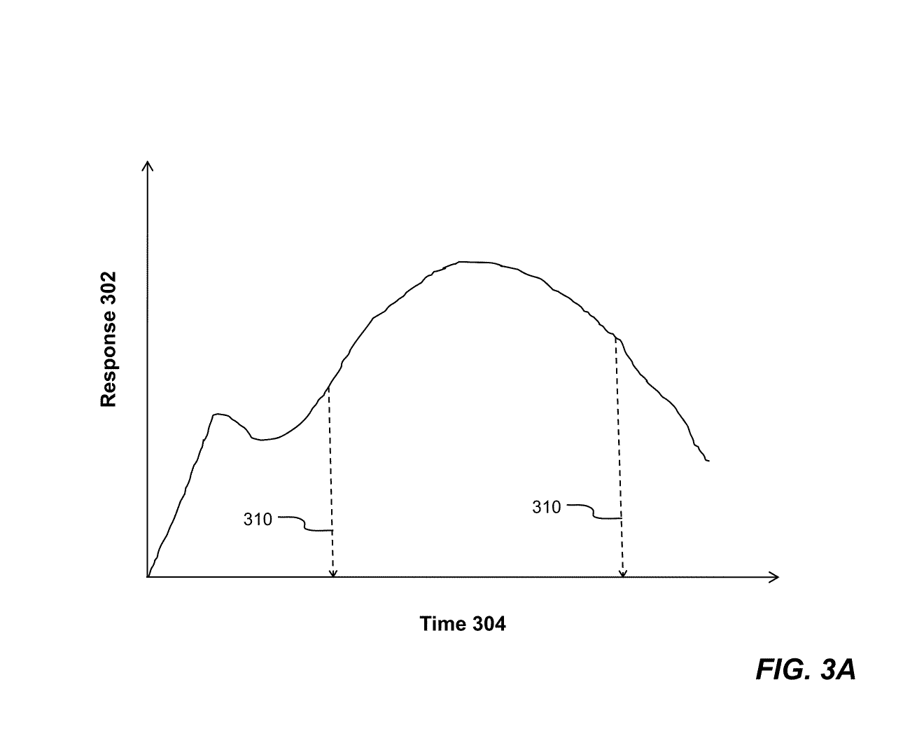

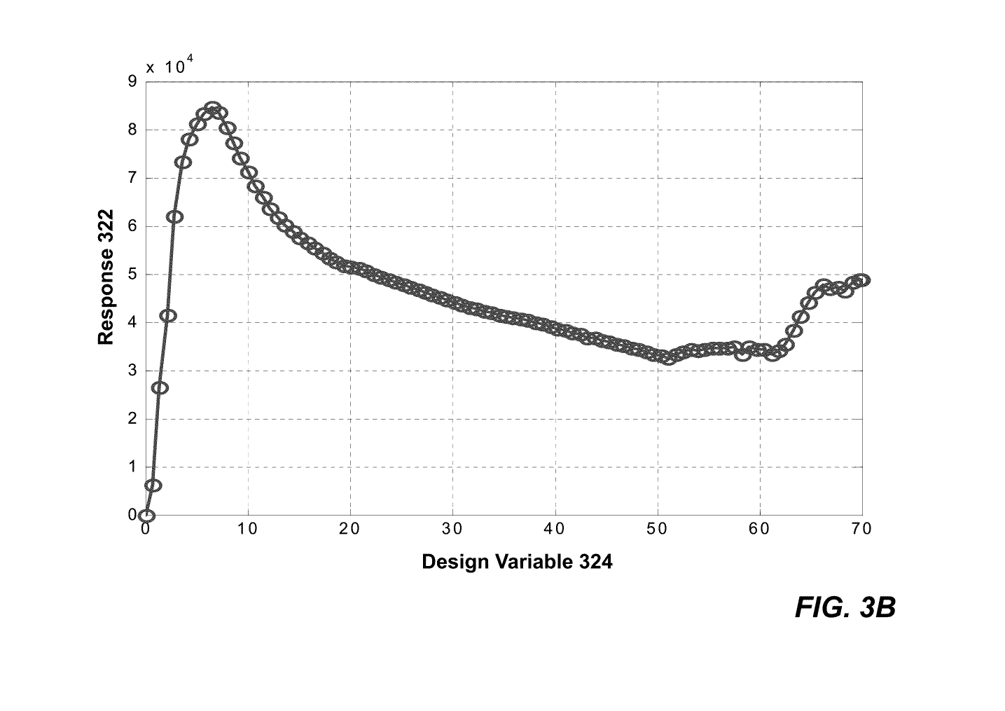

To achieve a design objective of the product, a structural response of interest is selected in the design optimization procedure. The simulated structural response can be accelerations at certain location (e.g., occupant's head), displacement of the knee, etc. FIG. 3A shows a plot of exemplary simulated structural behaviors and/or responses 302 versus time 304. Two dotted arrows 310 indicate exemplary predetermined solution cycles for snapshot structural analyses. At each predetermined solution cycle 310, the obtained structural behaviors of a configuration, using the explicit solution scheme, are used as the configuration for the implicit solution scheme. To optimize the design of the product, the simulated structural behaviors/responses of interest 322 is plotted against the selected design variable 324 shown in FIG. 3B.

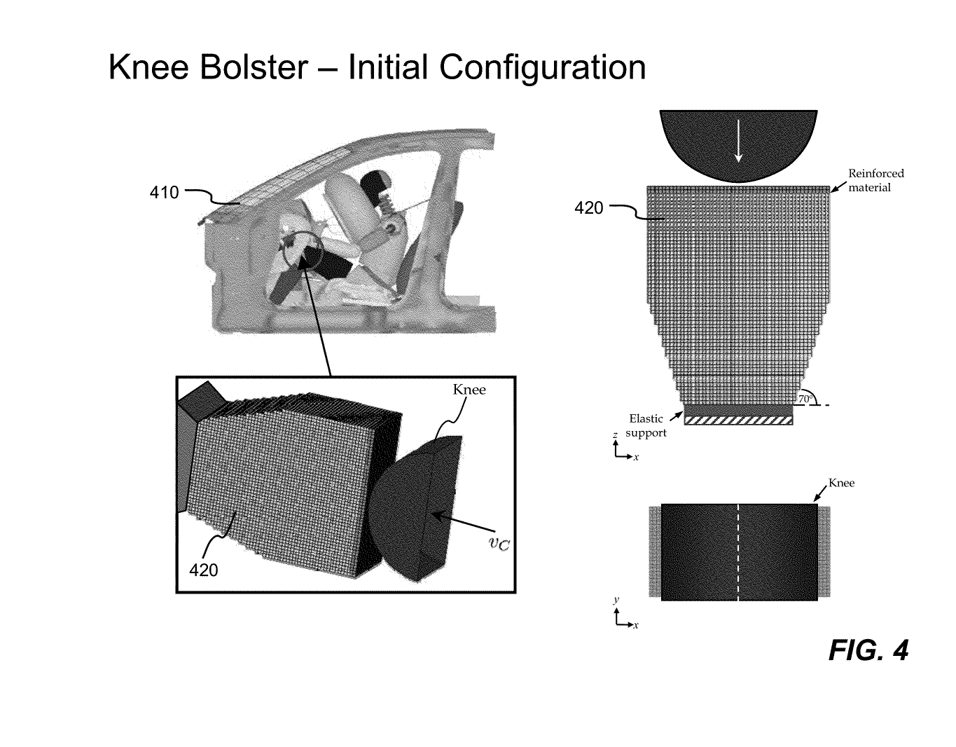

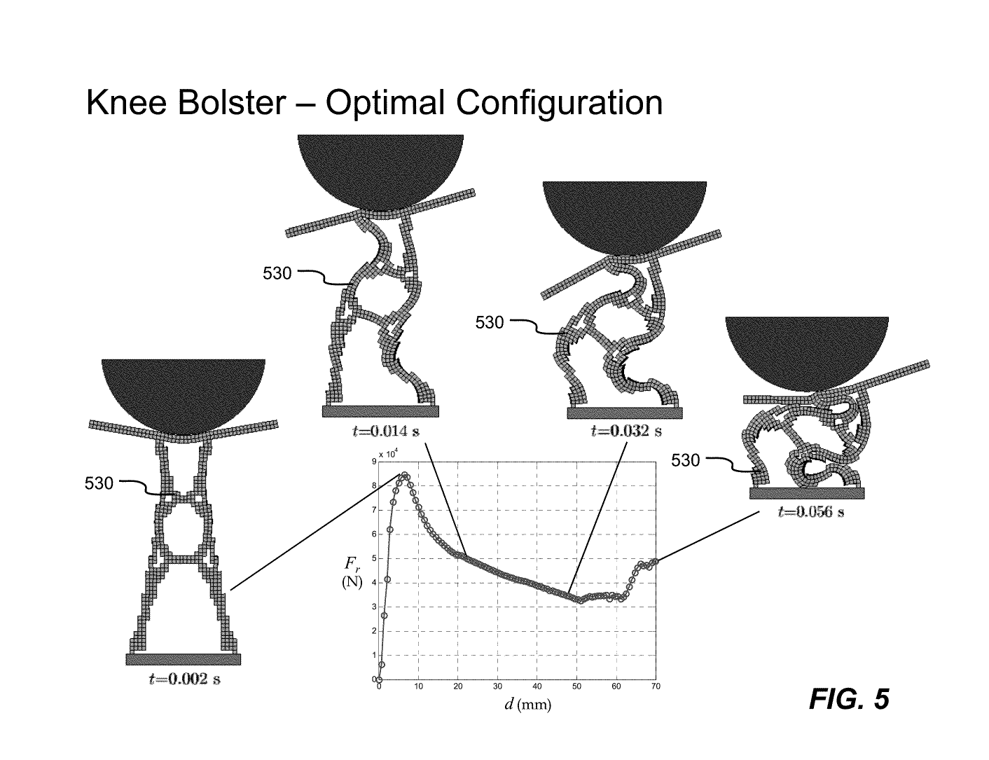

An optimization of an exemplary product (e.g., knee bolster 420 of a car 410) is shown in FIGS. 4-5. The design goal is to achieve an optimal design of the knee bolster 420 at certain weight limitation when the car 410 is in a collision (e.g., 35-mile collision to a wall). The design objective is to have a structure that can absorb maximum possible amount of energy while the design constraint is to maintain a peak load on driver's knee within a allowable value. The initial configuration of the knee bolster 420 is shown in FIG. 4 while the optimal configuration is shown in FIG. 5. Also shown in FIG. 5 are the initial and deformed geometries of the knee bolster 530 during the collision event. Finite element analysis results of the collision event are used in evaluating the design objective of the knee bolster.

To achieve the optimization of the exemplary product shown in FIGS. 4-5, material density of each finite element is designated as a selected design variable.

According to one aspect, the present invention is directed towards one or more computer systems capable of carrying out the functionality described herein. An example of a computer system 600 is shown in FIG. 6. The computer system 600 includes one or more processors, such as processor 604. The processor 604 is connected to a computer system internal communication bus 602. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. The computer 600 communicates with other computing devices over a data network based on a special set of rules (i.e., a protocol). One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600. In this document, the terms “computer program medium” and “computer usable medium” are used to generally refer to media such as removable storage drive 614, and/or a hard disk installed in hard disk drive 612. These computer program products are means for providing software to computer system 600. The invention is directed to such computer program products.

The computer system 600 may also include an input/output (I/O) interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the present invention as discussed herein. In particular, the computer programs, when executed, enable the processor 604 to perform features of the present invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results are computed and stored in the secondary memory 610 (i.e., hard disk drive 612). The status of the CAE analysis or design optimization (e.g., configuration at the end of each iteration) is reported to the user via the I/O interface 630 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the number of design objectives and variables has been shown as two, in reality, a larger number of design objectives and variables have been used. The number of design constraints can also be high. Furthermore, whereas finite element analysis has been described and shown for obtaining the structure responses, other types of CAE analysis such as finite difference analysis or meshless analysis, etc. may be used to achieve the same. Furthermore, whereas the internal energy absorption capability has been shown and described as design objective, other types of design objectives may be used, for example, maximum stress, maximum displacement, etc. While the methodology is demonstrated for topology optimization, it can be used with other optimization algorithms, e.g. shape and sizing optimization also. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of conducting design sensitivity analysis of a product based on simulated structural behaviors obtained from a time-marching simulation comprising:
receiving a finite element analysis (FEA) model representing a product in a computer system having a finite element analysis application module installed thereon, the FEA application module being configured for using both explicit and implicit solution schemes and allowing the FEA model to be switched back and forth between said explicit and said implicit solution schemes, the FEA model containing a plurality of nodes connected by a plurality of finite elements;
obtaining simulated structural behaviors of the product by conducting a time-marching simulation using the FEA model in the computer system with the explicit solution scheme, the time-marching simulation containing a plurality of solution cycles in time; and
conducting a design sensitivity analysis (DSA) by performing one or more snapshot structural analyses at respective predetermined solution cycles using the FEA model with the implicit solution scheme, each of said one or more snapshot structural analyses is based on the simulated structural behaviors of a configuration obtained at said respective predetermined solution cycles, wherein the DSA includes one or more partial derivatives of a structural response of interest versus a selected design variable.

2. The method of claim 1, wherein the DSA's results are used for improving the product.

3. The method of claim 2, wherein said improving the product is based on topology design optimization and said selected design variable is designated to be material density in each of the finite elements in the product being improved.

4. The method of claim 1, wherein said time-marching simulation includes simulating one or more loading conditions under which the product is designed and optimized.

5. The method of claim 4, wherein said product comprises an automobile.

6. The method of claim 5, wherein said one or more loading conditions comprises a collision of the automobile.

7. The method of claim 6, wherein the structural response is acceleration at an occupant's brain in the automobile.

8. The method of claim 4, wherein the product is a knee bolster in an automobile.

9. The method of claim 8, wherein the structural response is force on an occupant's knees in the automobile.

10. A system for conducting design sensitivity analysis of a product based on simulated structural behaviors obtained from a time-marching simulation comprising:
a main memory for storing computer readable code for a finite element (FEA) analysis application module, the FEA application module being configured for using both explicit and implicit solution schemes and allowing the FEA model to be switched back and forth between said explicit and said implicit solution schemes;
at least one processor coupled to the main memory, said at least one processor executing the computer readable code in the main memory to cause the FEA application module to perform operations by a method of:
receiving a FEA model representing a product, the FEA model containing a plurality of nodes connected by a plurality of finite elements;
obtaining simulated structural behaviors of the product by conducting a time-marching simulation using the FEA model in the computer system with the explicit solution scheme, the time-marching simulation containing a plurality of solution cycles in time; and
conducting a design sensitivity analysis (DSA) by performing one or more snapshot structural analyses at respective predetermined solution cycles using the FEA model with the implicit solution scheme, each of said one or more snapshot structural analyses is based on the simulated structural behaviors of a configuration obtained at said respective predetermined solution cycles, wherein the DSA includes one or more partial derivatives of a structural response of interest versus a selected design variable.

11. The system of claim 10, wherein the DSA's results are used for improving the product.

12. The system of claim 11, wherein said improving the product is based on topology design optimization and said selected design variable is designated to be material density in each of the finite elements in the product being improved.

13. A non-transitory computer-readable storage medium containing instructions for conducting design sensitivity analysis of a product based on simulated structural behaviors obtained from a time-marching simulation by a method comprising:
receiving a finite element analysis (FEA) model representing a product in a computer system having a finite element analysis application module installed thereon, the FEA application module being configured for using both explicit and implicit solution schemes and allowing the FEA model to be switched back and forth between said explicit and said implicit solution schemes, the FEA model containing a plurality of nodes connected by a plurality of finite elements;
obtaining simulated structural behaviors of the product by conducting a time-marching simulation using the FEA model in the computer system with the explicit solution scheme, the time-marching simulation containing a plurality of solution cycles in time; and
conducting a design sensitivity analysis (DSA) by performing one or more snapshot structural analyses at respective predetermined solution cycles using the FEA model with the implicit solution scheme, each of said one or more snapshot structural analyses is based on the simulated structural behaviors of a configuration obtained at said respective predetermined solution cycles, wherein the DSA includes one or more partial derivatives of a structural response of interest versus a selected design variable.

14. The non-transitory computer-readable storage medium of claim 13, wherein the DSA's results are used for improving the product.

15. The non-transitory computer-readable storage medium of claim 14, wherein said improving the product is based on topology design optimization and said selected design variable is designated to be material density in each of the finite elements in the product being improved.
